(19) United States
(12) Patent Application Publication
(10) Pub. No.: US 2013/0207539 A1
(43) Pub. Date: Aug. 15, 2013

(54) ORGANIC ELECTROLUMINESCENT DISPLAY DEVICE

(71) Applicants: Wintek (China) Technology Ltd., (US); WINTEK CORPORATION, (US)

(72) Inventors: Chong-Yang Fang, Taichung City (TW); Jyh-Yeuan Ma, Taoyuan County (TW); Hen-Ta Kang, Taichung City (TW); Yi-Shu Chen, Taichung City (TW)

(73) Assignees: WINTEK CORPORATION, Taichung City (TW); Wintek (China) Technology Ltd., Dongguan City (CN)

(21) Appl. No.: 13/748,608

(22) Filed: Jan. 24, 2013

(30) Foreign Application Priority Data
Feb. 10, 2012 (TW) 101104317

(51) Int. Cl. H05B 33/02

(52) U.S. Cl. CPC H05B 33/02
USPC 313/504

(57) ABSTRACT

An organic electroluminescent display device includes an upper substrate, a lower substrate, an organic electroluminescent layer, an upper electrode, a lower electrode and a light filter. The organic electroluminescent layer is disposed between the upper substrate and the lower substrate. The organic electroluminescent layer includes a plurality of first electroluminescent units, a plurality of second electroluminescent units and a plurality of third electroluminescent units. Each first electroluminescent unit is employed to emit light within a first wavelength range, each second electroluminescent unit is employed to emit light within a second wavelength range, and each third electroluminescent unit is employed to emit light within a third wavelength range. The light filter is disposed between the upper substrate and the lower substrate to block the light not within the first wavelength range, the second wavelength range and the third wavelength range.

### BACKGROUND OF THE INVENTION

1. Field of the Invention

The present invention relates to a display device, and more particularly, to an organic electroluminescent display device having a light filter to improve the quality of display.

2. Description of the Prior Art

Organic light emitting diode display, which has the advantages of absence of color filter, self-luminescence, and low power consumption, is always viewed as the best candidate to substitute for the liquid crystal display and become the main display technology of the next generation.

In order to improve the light extraction efficiency of organic light emitting diode display, conductive materials with high reflective ratio are generally chosen for an electrode to reflect the light that is not directly emitted toward the display front view, thereby increasing the display brightness.

Please refer to FIG. 1. FIG. 1 is a schematic diagram illustrating an ordinary organic light emitting diode display device. As shown in FIG. 1, an ordinary organic light emitting diode display device 900 comprises an upper substrate 910, a lower substrate 920, an upper electrode 930, a lower electrode 940 and an organic electroluminescent layer 950. The organic electroluminescent layer 950 is disposed between the upper substrate 910 and the lower substrate 920, the upper electrode 930 is disposed between the upper substrate 910 and the organic electroluminescent layer 950, and the lower electrode 940 is disposed between the lower substrate 920 and the organic electroluminescent layer 950. In addition, the lower electrode 940 is an electrode with high reflective ratio and an outer surface 910S of the upper substrate 910 is defined as the light-exiting face of the organic light emitting diode display device 900. Therefore, when the organic electroluminescent layer 950 is excited to emit light, upward excited light 991 is emitted toward the upper substrate 910 and downward excited light 992 is emitted toward the lower electrode 940. The downward excited light 992 can be reflected by the lower electrode 940 and become reflected light 999. The reflected light 999 and the upward excited light 991 thus become image light of the ordinary organic light emitting diode display device 900 and the light extraction efficiency of the organic light emitting diode display device 900 is improved. However, since the lower electrode 940 has a high reflective ratio, the incident ambient light 981 may also be reflected by the lower electrode 940 to become another reflected light 989 which will deteriorate the performances of the organic light emitting diode display device 900.

Furthermore, a method of employing a polarizer and a quarter wave plate to eliminate the reflected light from the incident ambient light is also utilized. But half of the excited light from the organic light emitting diode display device will be absorbed this way, and it will cause a huge decrease in the luminous intensity and the luminous efficacy of the organic light emitting diode display device.

### SUMMARY OF THE INVENTION

It is one of the objectives of the present invention to provide an organic electroluminescent display device. By disposing a light filter in the device, the influence of incident ambient light which deteriorates the performances of the organic electroluminescent display device can be decreased, and the light intensity of the display can be maintained. Then the light extraction efficiency and the image quality of the organic electroluminescent display device can be improved.

To achieve the purposes described above, a preferred embodiment of the present invention provides an organic electroluminescent display device. The organic electroluminescent display device comprises an upper substrate, a lower substrate, an organic electroluminescent layer, an upper electrode, a lower electrode, and a light filter. The lower substrate is disposed correspondingly to the upper substrate. The organic electroluminescent layer is disposed between the upper substrate and the lower substrate, and the organic electroluminescent layer comprises a plurality of first electroluminescent units, a plurality of second electroluminescent units and a plurality of third electroluminescent units. Each the first electroluminescent unit emits light within a first wavelength range, each the second electroluminescent unit emits light within a second wavelength range, and each the third electroluminescent unit emits light within a third wavelength range. The upper electrode is disposed between the organic electroluminescent layer and the upper substrate, and the lower electrode is disposed between the organic electroluminescent layer and the lower substrate. The light filter is disposed between the upper substrate and the lower substrate to block light not within the first wavelength range, the second wavelength range and the third wavelength range.

In the present invention, a light filter is disposed in an organic electroluminescent display device to block or absorb light not within the wanted wavelength range. The intensity of the image light can be maintained, and the influence of incident ambient light which deteriorates the performances of the organic electroluminescent display device can be effectively decreased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an ordinary organic light emitting diode display device.

FIG. 2 is a schematic diagram illustrating an organic electroluminescent display device according to a first preferred embodiment of the present invention.

FIG. 3 is a schematic diagram illustrating a displaying state of an organic electroluminescent display device according to the first preferred embodiment of the present invention.

FIG. 4 and FIG. 5 are schematic diagrams illustrating a spectrum of an organic electroluminescent display device according to the first preferred embodiment of the present invention.

FIG. 6 is a schematic diagram illustrating an organic electroluminescent display device according to a second preferred embodiment of the present invention.

FIG. 7 is a schematic diagram illustrating an organic electroluminescent display device according to a third preferred embodiment of the present invention.

FIG. 8 and FIG. 9 are schematic diagrams illustrating a spectrum of an organic electroluminescent display device according to a third preferred embodiment of the present invention.

FIG. 10 is a schematic diagram illustrating an organic electroluminescent display device according to a fourth preferred embodiment of the present invention.

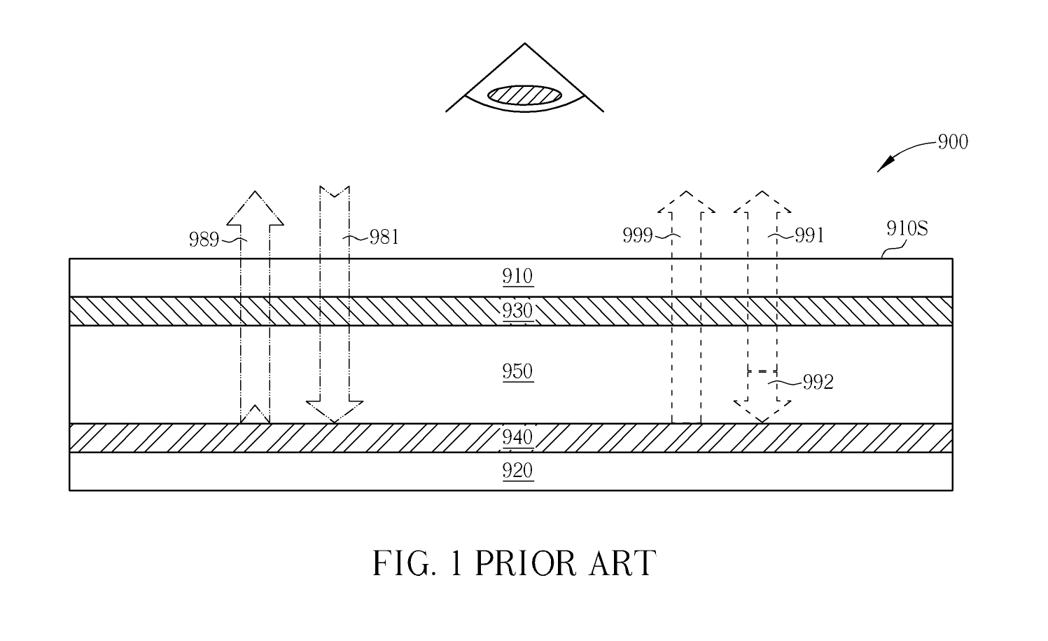

### DETAILED DESCRIPTION

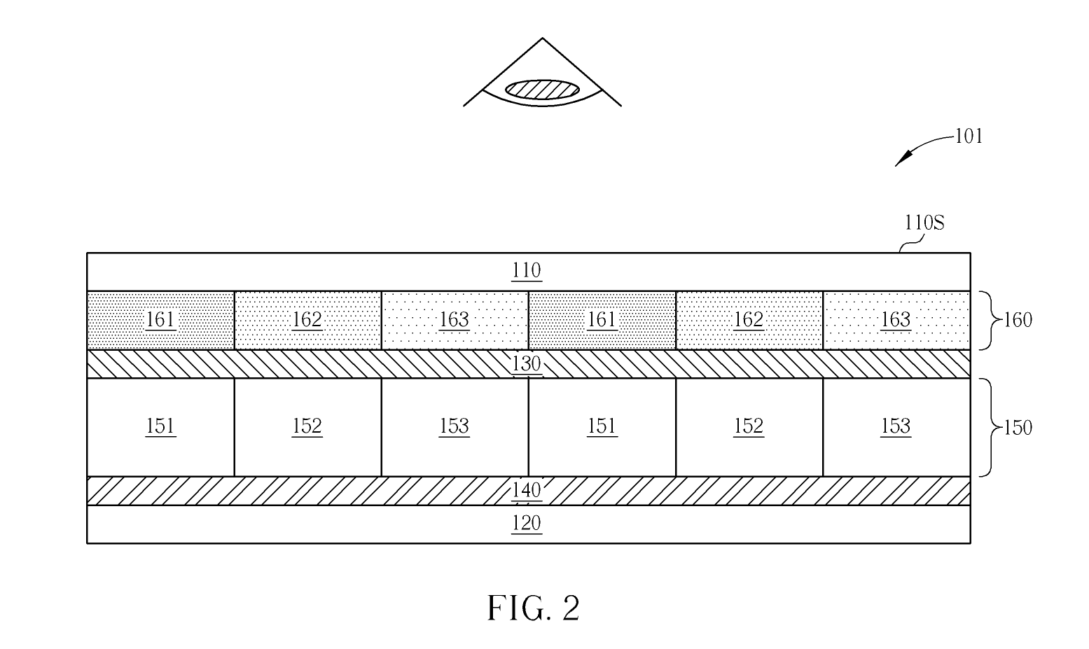

Please refer to FIG. 2. FIG. 2 is a schematic diagram illustrating an organic electroluminescent display device according to a first preferred embodiment of the present invention. Please note that the figures are only for illustration and the figures may not be to scale. The scale may be further modified according to different design considerations. As shown in FIG. 2, the present embodiment provides an organic electroluminescent display device 101. The organic electroluminescent display device 101 comprises an upper substrate 110, a lower substrate 120, an upper electrode 130, a lower electrode 140, an organic electroluminescent layer 150, and a light filter 160. The lower substrate 120 is disposed oppositely to the upper substrate 110. The organic electroluminescent layer 150 is disposed between the upper substrate 110 and the lower substrate 120. The upper electrode 130 is disposed between the organic electroluminescent layer 150 and the upper substrate 110. And the lower electrode 140 is disposed between the organic electroluminescent layer 150 and the lower substrate 120. By controlling the voltage between the upper electrode 130 and the lower electrode 140, the organic electroluminescent layer 150 can be excited to emit light for display effects. In this embodiment, the organic electroluminescent layer 150 may comprise a plurality of first electroluminescent units 151, a plurality of second electroluminescent units 152, and a plurality of third electroluminescent units 153. Each of the first electroluminescent units 151 may be used to emit light within a first wavelength range, each of the second electroluminescent units 152 may be used to emit light within a second wavelength range, and each of the third electroluminescent units 153 may be used to emit light within a third wavelength range. Moreover, the lower electrode 140 in this embodiment may be a reflective electrode, and it can be made of at least one of high reflective ratio materials such as Al, Cu, Ag, Cr, Ti, Mo, a stack layer of the above-mentioned materials, or an alloy of the above-mentioned materials, but not limited thereto. The upper electrode 130 preferentially comprises a transparent conductive material such as ITO (indium tin oxide), IZO (indium zinc oxide) and AZO (aluminum zinc oxide), but not limited thereto. As the lower electrode 140 may be an electrode with a high reflective ratio, the outer surface 1105 of the upper substrate 110 may be defined as the image light-exiting face of the organic electroluminescent display device 101. In addition, the light filter 160 in this embodiment is disposed between the upper substrate 110 and the lower substrate 120, more precisely disposed between the upper substrate 110 and the organic electroluminescent layer 150, to block light not within the first wavelength range, the second wavelength range, and the third wavelength range. It is worth noting that the light filter 160 is preferentially capable of absorbing the light not within the first wavelength range, the second wavelength range, and the third wavelength range so as to block the light not within the first wavelength range, the second wavelength range, and the third wavelength range, but the present invention is not limited to this. In other preferred embodiments of the present invention, other appropriate approaches may also be used to block the light not within the first wavelength range, the second wavelength range, and the third wavelength range.

To explain more clearly, the light filter 160 in this embodiment can comprise a first light filter unit 161, a second light filter unit 162 and a third light filter unit 163 to block the light not within the first wavelength range, the second wavelength range and the third wavelength range respectively. And the first light filter unit 161 is disposed correspondingly to the first electroluminescent unit 151, the second light filter unit 162 is disposed correspondingly to the second electroluminescent unit 152, and the third light filter unit 163 is disposed correspondingly to the third electroluminescent unit 153. In this embodiment, each the first electroluminescent unit 151 can be used to emit blue light, each the second electroluminescent unit 152 can be used to emit green light, and each the third electroluminescent unit 153 can be used to emit red light. Full color display can be achieved by mixing those lights, but not limited thereto. The corresponding first wavelength range is substantially between 435 nm and 480 nm, the corresponding second wavelength range is substantially between 500 nm and 560 nm, and the corresponding third wavelength range is substantially between 605 nm and 705 nm, but the present invention is not limited to this. In other preferred embodiments of the present invention, each of the first electroluminescent units 151, each of the second electroluminescent units 152, and each of the third electroluminescent units 153 may be used to emit light within other wavelength ranges for other considerations. In addition, the light filter 160 can comprise a dyeing resin. In other words, a dyeing resin of different composition can be put in the first light filter unit 161, the second light filter unit 162 and the third light filter unit 163 to make the first light filter unit 161 capable of blocking light not within the first wavelength range, to make the second light filter unit 162 capable of blocking light not within the second wavelength range, and to make the third light filter unit 163 capable of blocking light not within the third wavelength range respectively, but the present invention is not limited to this. In other preferred embodiments of the present invention, other appropriate methods may also be applied to make each of the light filter units capable of blocking light within different wavelength range.

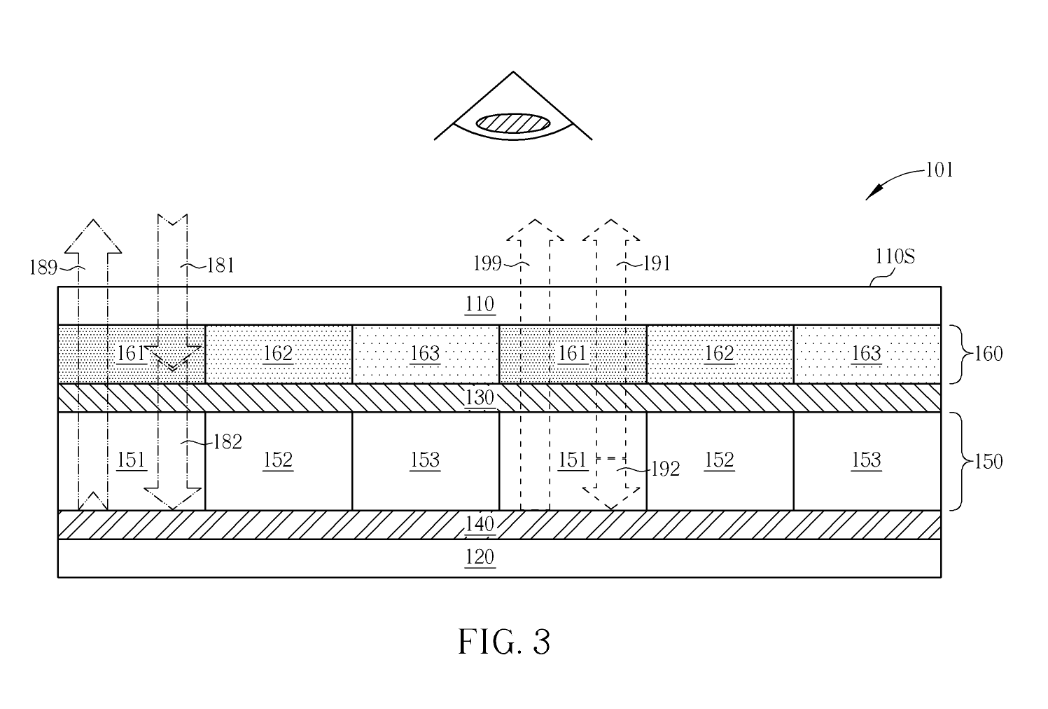

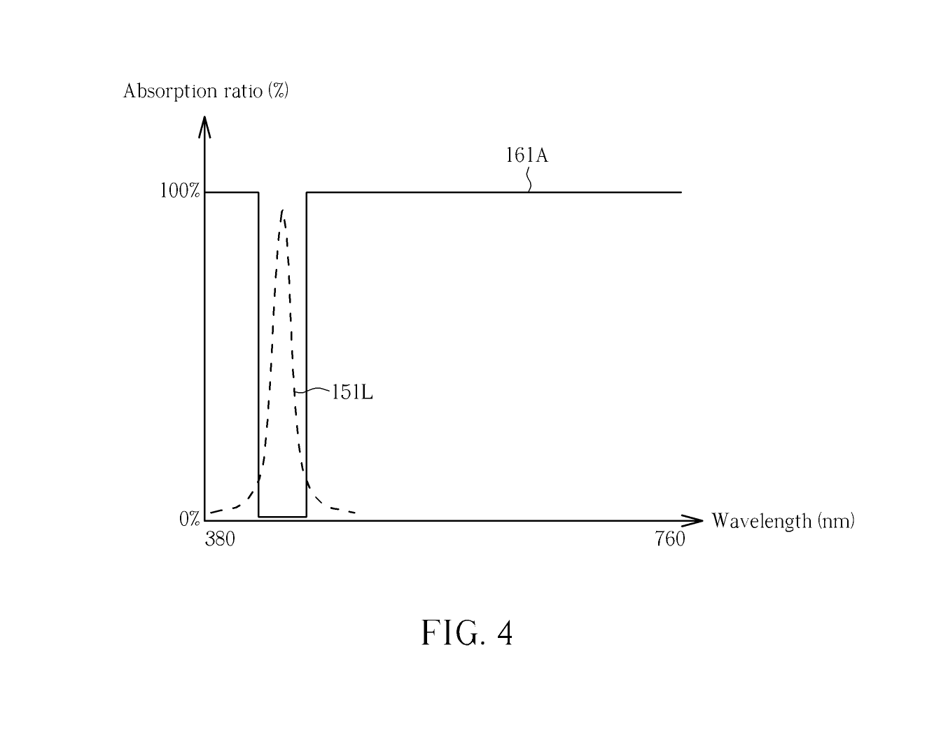

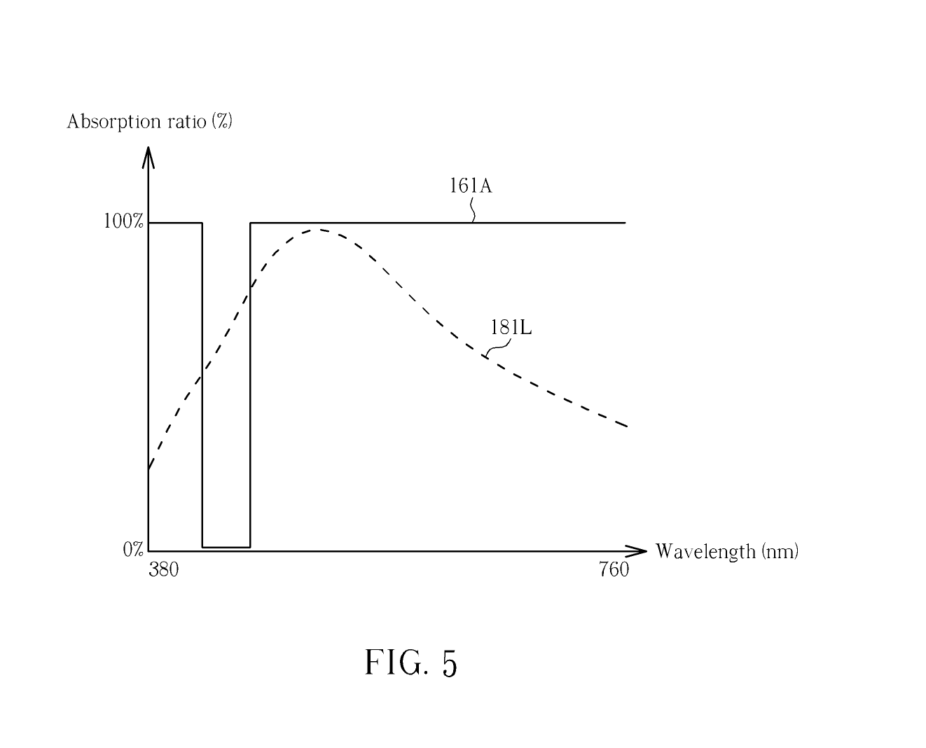

Please refer to FIGS. 3-5. FIG. 3 is a schematic diagram illustrating a displaying state of an organic electroluminescent display device according to the first preferred embodiment of the present invention. FIG. 4 and FIG. 5 are schematic diagrams illustrating a display spectrum of an organic electroluminescent display device according to the first preferred embodiment of the present invention. As shown in FIG. 3, when the organic electroluminescent layer 150 is excited to emit light, upward light 191 is emitted toward the upper substrate 110 and downward light 192 is emitted toward the lower substrate 120. Since the lower electrode 140 may be a reflective electrode with a high reflective ratio, the downward light 192 can be reflected by the lower electrode 140 and become reflected light 199. The reflected light 199 and the upward light 191 may be combined together to provide display effects. In addition, incident ambient light 181 which goes through the light filter 160 will become transmitted light 182. The transmitted light 182 can also be reflected by the lower substrate 140 to become another reflected light 189.

As shown in FIG. 3 and FIG. 4, a curve 151L represents the emitting light intensity distribution of the first electroluminescent unit 151, and line 161A represents the light absorption ratio distribution of the first light filter unit 161. The light absorption ratio of the line 161A is around 100% at regions outside the corresponding wavelength range of the curve 151L. There is almost no absorption occurring at the wavelength range corresponding to the curve 151L. In other words, the first light filter unit 161 can absorb the light not within the wavelength range of the emitted light by the first electroluminescent unit 151, and can almost let the light within the wavelength range of the emitted light by the first electroluminescent unit 151 pass through. Similarly, the second light filter unit 162 can absorb the light not within the wavelength range of the emitted light by the second electroluminescent unit 152, and can almost let the light within the wavelength range of the emitted light by second electroluminescent unit 152 pass through. The third light filter unit 163 can absorb the light not within the wavelength range of emitted light by the third electroluminescent unit 153, and can almost let the light within the wavelength range of emitted light by the third electroluminescent unit 153 pass through.

Further, as shown in FIG. 3 and FIG. 5, the curve 181L represents the intensity distribution of the incident ambient light 181. The light absorption ratio of the line 161A is around 100% at regions outside the first wavelength range. In other words, the first light filter unit 161 can absorb most parts of the incident ambient light 181, and reduce the intensity of the transmitted light 182 and the reflected light 189. Similarly, the second light filter unit 162 can absorb the incident ambient light 181 not within the second wavelength range, and reduce the intensity of the transmitted light 182 and the reflected light 189. The third light filter unit 163 can absorb the incident ambient light 181 not within the third wavelength range, and reduce the intensity of the transmitted light 182 and the reflected light 189. Accordingly, with the first light filter unit 161 corresponding to the first electroluminescent unit 151, the second light filter unit 162 corresponding to the second electroluminescent unit 152, and the third light filter unit 163 corresponding to the third electroluminescent unit 153, the influence of incident ambient light 181 which deteriorates the performances of the organic electroluminescent display device can be effectively decreased, and the intensity of the upward light 191 and the reflected light 199 can be maintained. Moreover, the organic electroluminescent display device 101 in this embodiment may comprise an active matrix organic light emitting diode (AMOLED) display or a passive matrix light emitting diode (PMOLED) display. When the organic electroluminescent display device 101 is an AMOLED, it may comprise a plurality of controlling elements (not shown) disposed on the upper substrate 110 or on the lower substrate 120, in order to control each first electroluminescent unit 151, each second electroluminescent unit 152 and each third electroluminescent unit 153. When each controlling element is disposed on the lower substrate 120, the organic electroluminescent display device 101 may be regarded as a top emission organic electroluminescent display device. And when each controlling element is disposed on the upper substrate 110, the organic electroluminescent display device 101 may be regarded as a bottom emission organic electroluminescent display device, but not limited thereto.

The following description is based on different embodiments of the organic electroluminescent display device in the present invention. To simplify the description, the following description will focus on the differences among embodiments rather than the similar parts. Furthermore, the same reference numbers are used in each description of embodiments for the convenience of cross-reference.

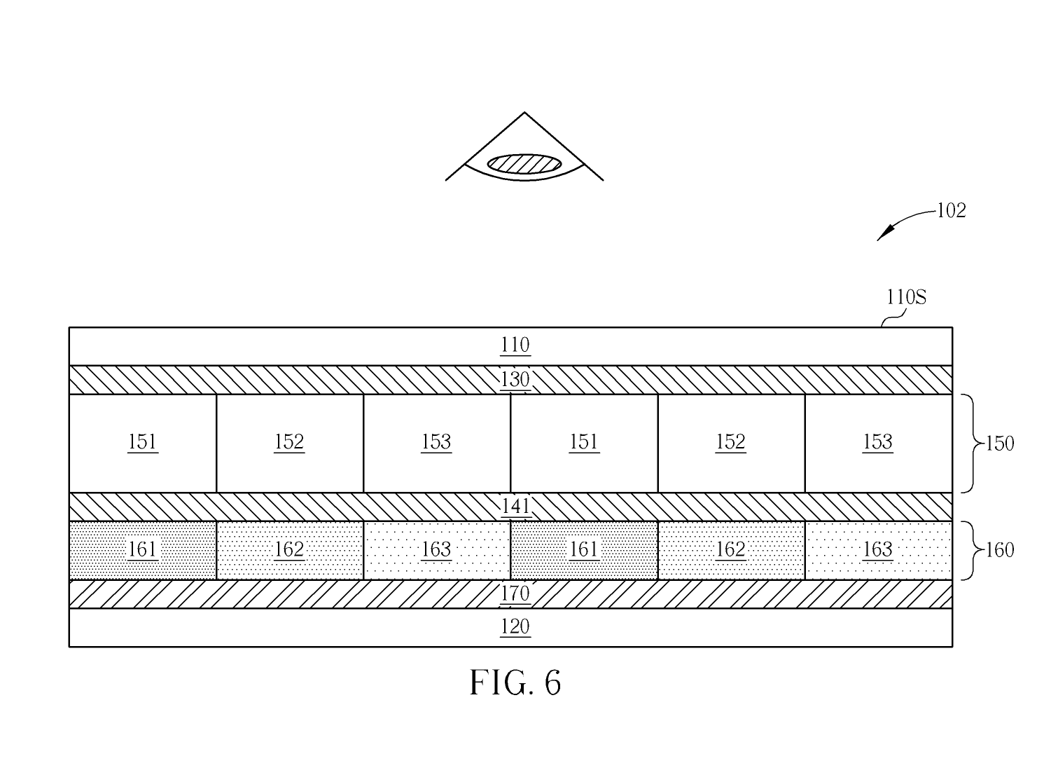

Please refer to FIG. 6. FIG. 6 is a schematic diagram illustrating an organic electroluminescent display device according to a second preferred embodiment of the present invention. As shown in FIG. 6, an organic electroluminescent display device 102 in this embodiment compared to the first preferred embodiment further comprises a reflective layer 170 disposed between a lower electrode 141 and a lower substrate 120. It is worth noting that the lower electrode 141 in this embodiment is preferably a transparent electrode because of the disposition of the reflective layer 170. The lower electrode 141 can comprise a transparent conductive material such as ITO, IZO, or AZO, but not limited thereto. Furthermore, the light filter 160 in this embodiment is disposed between the reflective layer 170 and the lower electrode 141. Because of the disposition of the reflective layer 170, the material of the lower electrode 141 is more selective and the structure and the design of the organic electroluminescent display device 102 may be more flexible. The organic electroluminescent display device 102 in this embodiment is similar to the organic electroluminescent display device 101 in the first preferred embodiment except for the disposition of the reflective layer 170 and the stacking structure between the light filter 160 and the organic electroluminescent layer 150. In other preferred embodiments of the present invention, the light filter 160 can be disposed between the upper substrate 110 and the upper electrode 130 to reduce the bad influence of incident ambient light.

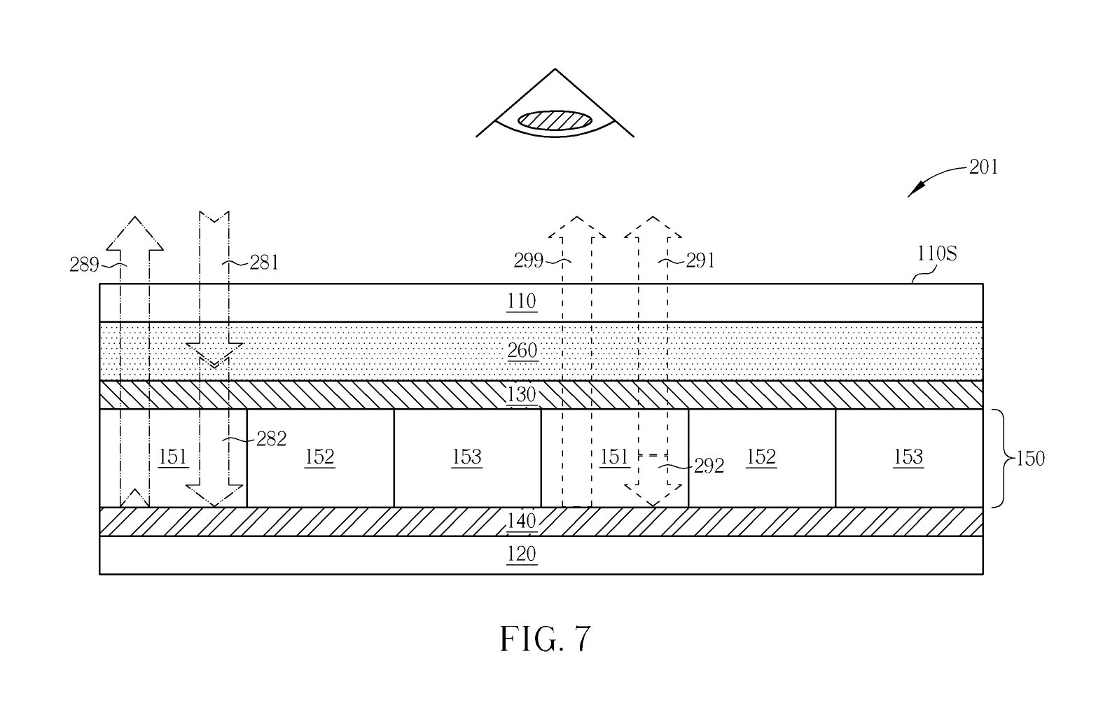

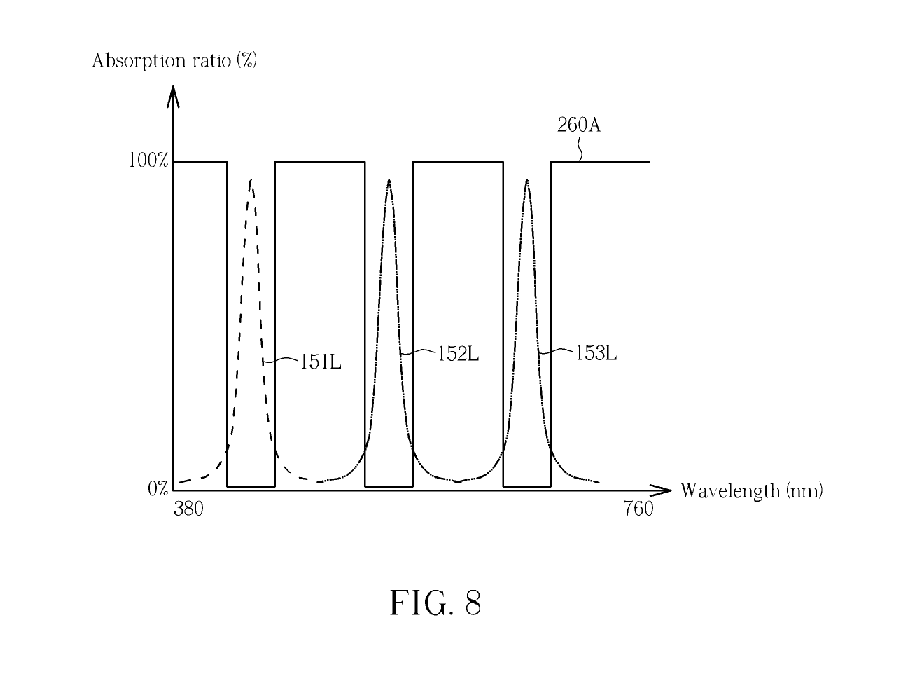

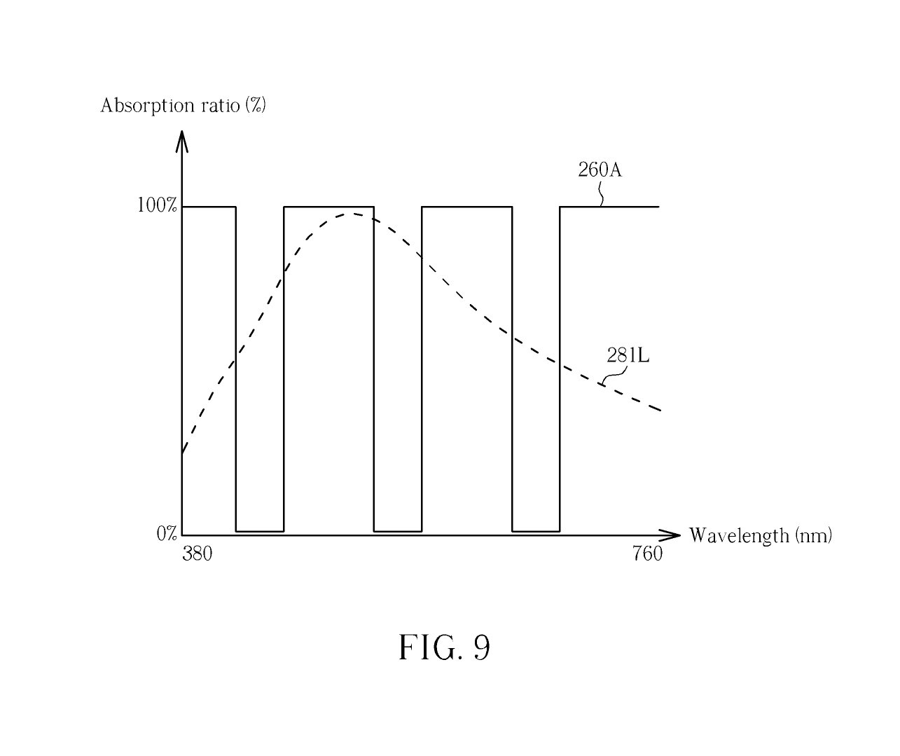

Please refer to FIGS. 7-9. FIG. 7 is a schematic diagram illustrating an organic electroluminescent display device according to a third preferred embodiment of the present invention. FIG. 8 and FIG. 9 are schematic diagrams illustrating the spectrum of an organic electroluminescent display device according to the third preferred embodiment of the present invention. As shown in FIG. 7, an organic electroluminescent display device 201 in this embodiment compared to the first preferred embodiment comprises a light filter 260. The light filter 260 includes a multi-layer interference film. In other words, the light filter 260 may be used to block the light not within the first wavelength range, the second wavelength range and the third wavelength range by the structure of the multi-layer interference film. In this embodiment, when the organic electroluminescent layer 150 is excited to emit light, upward light 291 is emitted toward the upper substrate 110 and downward light 292 is emitted toward the lower substrate 120. Since the lower electrode 140 may be a reflective electrode with a high reflective ratio, the downward light 292 can be reflected by the lower electrode 140 and become reflected light 299. The reflected light 299 and the upward light 291 may be combined together to provide the display effects. In addition, the incident ambient light 281, which irradiates toward the organic electroluminescent display device 201, may become transmitted light 282 after passing through the light filter 260. The transmitted light 282 can also be reflected by the lower substrate 140 to become another reflected light 289.

Please refer to FIG. 7 and FIG. 8. The curve 151L represents the emitted light intensity distribution of the first electroluminescent unit 151, the curve 152L represents the emitted light intensity distribution of the second electroluminescent unit 152, and the curve 153L represents the emitted light intensity distribution of the third electroluminescent unit 153. The line 260A represents the light absorption ratio distribution of the light filter 260. The light absorption ratio of the line 260A is around 100% at regions outside the corresponding wavelength ranges of the curve 151L, 152L, and 153L. There is almost no absorption occurring at the wavelength ranges corresponding to the curves 151L, 152L and 153L. In other words, the light filter 260 can absorb the light not within the wavelength ranges of the light emitted by the first electroluminescent unit 151, the second electroluminescent unit 152 and the third electroluminescent unit 153, and can let almost all the light within the wavelength ranges of the light emitted by the first electroluminescent unit 151, the second electroluminescent unit 152 and the third electroluminescent unit 153 go through. And as shown in FIG. 7 and FIG. 9, the curve 281L represents the intensity distribution of the incident ambient light 281. The light absorption ratio of the line 260A is around 100% at regions outside the first wavelength range, the second wavelength range, and the third wavelength range. In other words, the light filter unit 260 can absorb most parts of the incident ambient light 281, and reduce the intensities of the transmitted light 282 and the reflected light 289. Accordingly, with the light filter unit 260 corresponding to the first electroluminescent unit 151, the second electroluminescent unit 152 and the third electroluminescent unit 153, the influence of incident ambient light 281 which deteriorates the performances of the organic electroluminescent display device can be effectively decreased, and the intensity of the upward light 291 and the reflected light 299 can be maintained. The organic electroluminescent display device 201 in this embodiment is similar to the organic electroluminescent display device 101 in the first preferred embodiment except for the light filter 260.

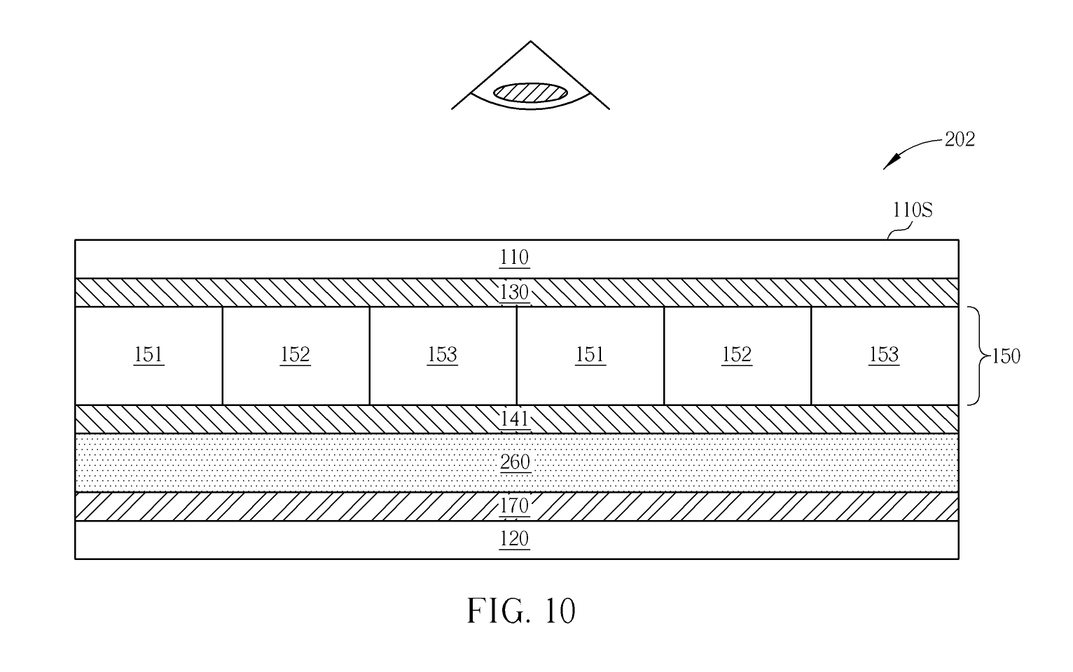

Please refer to FIG. 10. FIG. 10 is a schematic diagram illustrating an organic electroluminescent display device according to a fourth preferred embodiment of the present invention. As shown in FIG. 10, an organic electroluminescent display device 202 in this embodiment compared to the third preferred embodiment further comprises a reflective layer 170 disposed between the lower electrode 141 and the lower substrate 120. It is worth noting that the lower electrode 141 in this embodiment is preferably a transparent electrode because of the disposition of the reflective layer 170. Furthermore, the light filter 260 in this embodiment is disposed between the reflective layer 170 and the lower electrode 141. Because of the disposition of the reflective layer 170, the material of the lower electrode 141 is more selective and the structure and the design of the organic electroluminescent display device 202 may be more flexible. The organic electroluminescent display device 202 in this embodiment is similar to the organic electroluminescent display device 201 in the third preferred embodiment except for the disposition of the reflective layer 170 and the stacking structure between the light filter 260 and the organic electroluminescent layer 150. In other preferred embodiments of the present invention, the light filter 260 can be disposed between the upper substrate 110 and the upper electrode 130 to decrease the bad influence of incident ambient light.

To summarize the above descriptions, in the present invention, a light filter is disposed in an organic electroluminescent display device to block most parts of the incident ambient light and decrease the influence of the reflected light which deteriorates the performances of the organic electroluminescent display device. In this way, the intensity of the image light can be maintained and the display quality can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An organic electroluminescent display device, comprising:
an upper substrate;
a lower substrate, disposed correspondingly to the upper substrate;
an organic electroluminescent layer, disposed between the upper substrate and the lower substrate, wherein the organic electroluminescent layer comprises:
a plurality of first electroluminescent units, wherein each of the first electroluminescent units is used to emit light within a first wavelength range;
a plurality of second electroluminescent units, wherein each of the second electroluminescent units is used to emit light within a second wavelength range; and
a plurality of third electroluminescent units, wherein each of the third electroluminescent units is used to emit light within a third wavelength range;
an upper electrode, disposed between the organic electroluminescent layer and the upper substrate;
a lower electrode, disposed between the organic electroluminescent layer and the lower substrate; and
a light filter, disposed between the upper substrate and the lower substrate for blocking light not within the first wavelength range, the second wavelength range, and the third wavelength range.

2. The organic electroluminescent display device of claim 1, wherein the light filter comprises: at least one first light filter unit, disposed correspondingly to each first electroluminescent unit, wherein the first light filter unit is used to block light not within the first wavelength range;
at least one second light filter unit, disposed correspondingly to each second electroluminescent unit, wherein the second light filter unit is used to block light not within the second wavelength range; and
at least one third light filter unit, disposed correspondingly to each third electroluminescent unit, wherein the third light filter unit is used to block light not within the third wavelength range.

3. The organic electroluminescent display device of claim 2, wherein the light filter comprises dyeing resin.

4. The organic electroluminescent display device of claim 1, wherein the light filter comprises an multi-layer interference film.

5. The organic electroluminescent display device of claim 1, wherein the lower electrode is a reflective electrode.

6. The organic electroluminescent display device of claim 1, further comprising a reflective layer disposed between the lower electrode and the lower substrate.

7. The organic electroluminescent display device of claim 6, wherein the light filter is disposed between the reflective layer and the lower substrate.

8. The organic electroluminescent display device of claim 1, wherein the light filter is disposed between the upper substrate and the organic electroluminescent layer.

9. The organic electroluminescent display device of claim 1, wherein the first wavelength range is between 435 nm and 480 nm, the second wavelength range is between 500 nm and 560 nm, and the third wavelength range is between 605 nm and 705 nm.
